(19) United States
(12) Patent Application Publication
(10) Pub. No.: US 2017/0358044 A1
(43) Pub. Date: Dec. 14, 2017

(54) Arrangement for data distribution in an intellectual property management system

(71) Applicant: Berggren Oy, Helsinki (FI)

(72) Inventors: Katriina Ropponen, Helsinki (FI); Pekka Jussila, Helsinki (FI); Marjo Pihlajamäki, Helsinki (FI); Heikki Kinnunen, Helsinki (FI)

(73) Assignee: Berggren Oy, Helsinki (FI)

(21) Appl. No.: 15/545,344

(22) PCT Filed: Jan. 21, 2015
(86) PCT No.: PCT/FI2015/050030

§ 371 Date: Jul. 21, 2017

(51) Int. Cl. G06Q 50/18; G06Q 10/10; G06F 17/30; G06F 3/0484

(52) U.S. Cl. CPC G06Q 50/184; G06F 17/30604; G06F 17/30368; G06Q 10/10; G06F 3/04847

(57) ABSTRACT

The invention relates to an arrangement for data distribution in an intellectual property (IP) management system. Also, the invention relates to a method for data distribution in an IP management system. Moreover, the invention relates to a server for data distribution in an IP management system. The invention relates also to a computer program product implementing the data distribution in an IP management system. The invention concerns effective self-direction of data on the server according to a data structure. The self-direction of the data is achieved by enabling one or more users to work asynchronously with capability to define the relevant data to be distributed that the server then distributes from an IP Case to an IP Family level or from IP Family level to one or more IP Cases in the IP Family according to the data structure on the server.

### TECHNICAL FIELD OF THE INVENTION

The invention relates to an arrangement for data distribution in an intellectual property (IP) management system. Also, the invention relates to a method for data distribution in an IP management system. Moreover, the invention relates to a server for data distribution in an IP management system. The invention relates also to a computer program product implementing the data distribution in an IP management system.

### BACKGROUND OF THE INVENTION

Managing IP by means of computer-based systems is well-known and various commercial software systems are available on the markets for the said purpose. The said software systems comprise solutions for managing intellectual property portfolios of patents, utility models, trademarks and industrial designs and applications of such intellectual property rights, for example. The said software systems or managing IP portfolios enable control of deadlines, renewals and costs of intellectual property rights being part of the managed IP portfolio.

Some of the said software systems or managing IP portfolios enable also a more detailed task management in relation to an individual piece of intellectual property, such as, for example, a single patent application or a single trademark application, which belongs to the managed IP portfolio. The task management may enable giving assignments for persons responsible for managing a single application, for example.

The said systems may also enable storing documents and metadata related to the documents. The metadata enables storing the documents according to the individual intellectual property right that a document relates to. The metadata also enables searching documents from the system.

The present systems enable the users to add comments to an individual intellectual property right item, such as a patent or a patent application, for example. A group of intellectual property right items having a certain relation to each other may form an IP family. The present systems may even enable the users to add comments to a family of intellectual property right items.

The present systems for IP management lack certain aspects of efficient management of IP items and families of intellectual property items. When handling the prosecution and management of an IP item, data relevant for further actions regarding the same item, a whole family of related IP items or another IP item in the same family may become known. For example cited documents, arguments from examiners or patent attorneys and search results may be relevant to more than one patent application in a patent family. Over time there may be different persons responsible for prosecution and management of IP items within the IP family. The amount of data within an IP Family may grow over the years of prosecution and information that is valuable for more than one IP item in the IP Family becomes more difficult to find. This causes more work to proprietors and attorneys. It also raises the costs of managing the IP portfolios. Efficient distribution of data from one IP item to a level of IP family or from the level of IP Family to an IP item being added to the IP family is needed.

To collect and distribute the data to all IP items that the specific data may be relevant to, it has to be separately updated to each of the items and to the family level of the connected IP items in the present systems. In practice, that would be inefficient copy-pasting the data from one item to another and losing the full context and relations to which the data relates to. Further, also searching the data that is relevant on the level of the IP family is difficult and inefficient. The present systems lack solutions that allow distributing data that has IP family level importance and becomes known in relation to one IP item to the level of the IP family. Present systems also lack solutions that allow distribution of data from the level of IP family to single IP items.

### List of Terms

Certain terms are used to describe the present invention and the following explanations of the terms are given for convenience in the context of the present invention:

An IP Case means an IP item such as a patent, a patent application, a utility model, a utility model application, a trademark, a trademark application, an industrial design or an industrial design application. An IP Case may belong to one or more IP Families. An IP Case may also be called as an intellectual property right application or an intellectual property right registration.

An IP Family means a group of IP Cases related to each other. For example, an IP Family may be a group of patents and patent applications in various countries regarding the same invention and originating from a certain first filed patent application. An IP Family may also be a group of trademarks and trademark applications originating from a certain first filed trademark application or registration. Other relations than the ones given as examples are, naturally, possible between the IP Cases that belong to an IP Family. An IP Family may also be called as a group of intellectual property right applications or registrations.

A Workspace means a deadline, a task, a decision or other such matter that requires a reaction from one or more users. There can be one or more Workspaces for an IP Case. Further, there can be one or more Workspaces for an IP Family. The at least one element of Workspace in a data structure corresponds to at least one of the following: a deadline, a task, a decision or a notification in relation to the at least IP Case and the at least one IP Family.

A Log for Collecting comments may keep a list of data added or changed in one or more IP Cases or IP Families. The Log for Collecting comments in an item keeping a list of data added or changed in one or more IP Cases or IP Families.

### SUMMARY OF THE INVENTION

The object of the present invention is to provide an arrangement, a method, a server and a computer program product for data distribution in an IP management system. Also, the object of the present invention is to provide a solution that enables distribution of data in IP management system from one or more IP Cases to a level of an IP Family. Further, the object of the present invention is to provide a solution that enables distribution of data in IP management system from the level of an IP Family to one or more IP Cases in the family.

Moreover, the object of the present invention is to enable the distribution of data in IP management system from the level of an IP Family to one or more IP Cases in the IP family regardless of a state of work in one or more IP Cases or one or more IP Families on a level of at least one of the following: an IP Case and an IP Family.

Finally, the object of the present invention is to enable the users of the IP management system to have direct access to important data regardless of the level of system on which each user is working. IP Family level data that is important also on the level of a single IP Case that belongs to the IP Family, should be directly visible and accessible on the level of the IP Case. Similarly, IP Case level data that may have relevance also on the level of the IP Family that the IP Case belongs to, should be directly visible and accessible on the level of the IP Family.

The objects of the present invention are fulfilled by providing an arrangement for data distribution in an intellectual property, IP, management system comprising:
at least one user access device configured to run a user interface providing access to the IP management system with a capability to mark any data in at least one of the following: one or more IP application or registration, called as IP Case, or one or more group of IP applications or registrations, called as IP Family, for distribution within the IP management system; and
at least one server configured to distribute the data marked for distribution on the at least one user access device from the at least one IP Case to the at least one IP Family or from the at least one IP Family to the at least one IP Case that belongs to the IP Family wherein the server further comprises a data structure for linking the data marked for distribution on the user access device as follows:
the data marked for distribution from the at least one IP Case to the at least one IP Family, is linked to the at least one IP Family according to the data structure; and
the data marked for distribution from the at least one IP Family to the at least one IP Case that belongs to the IP Family, is linked to the at least one IP Case according to the data structure; and
   the server is configured to publish the said data according to the linking in the data structure for a user's access on the user interface run by any user access device.

Also the objects of the present invention are fulfilled by providing a server for data distribution in an intellectual property, IP, management system comprising:
at least one processor;
at least one data communication interface;
at least one memory including a computer program code and a data structure; and
the at least one memory, the computer program code and the data structure configured to, with the at least one processor, cause the server at least to distribute any data marked for distribution in at least one IP application or registration, called as IP Case, or in at least one group of IP applications or registrations, called as IP Family, on a user interface run by at least one user access device providing access to the IP management system
   wherein the server is further configured to publish the said data for a user's access on the user interface providing access to the IP management system run by any user access device according to the data structure linking the said data as follows:
the data marked for distribution from the at least one IP Case to the at least one IP Family, is linked to the at least one IP Family; and
the data marked for distribution from the at least one IP Family to the at least one IP Case that belongs to the IP Family, is linked to the at least one IP Case.

Moreover the objects of the present invention are fulfilled by providing a method for data distribution in an intellectual property, IP, management system comprising:
marking any data in at least one IP application or registration, called as IP Case, or in at least one group of IP applications or registrations, called as IP Family, for distribution according to at least one of the following: from the at least one IP Case to the at least one IP Family and from the at least one IP Family to the at least one IP Case that belongs to the IP Family on a user interface providing access to the IP management system run by any user access device; and
linking the data marked for distribution on at least one server according to a data structure
   wherein the method further comprises linking the said data on the at least one server according to the data structure as follows:
the data marked for distribution from the at least one IP Case to the at least one IP Family, is linked to the at least one IP Family;
the data marked for distribution from the at least one IP Family to the at least one IP Case that belongs to the IP Family, is linked to the at least one IP Case; and
   the said data is published by the at least one server according to linking in the data structure for a user's access on the user interface run by any user access device.

Finally the objects of the present invention are fulfilled by providing a computer program product on a non-transitory media for data distribution in an intellectual property, IP, management system comprising:
a computer readable code for marking any data in at least one IP application or registration, called as IP Case, or in at least one group of IP applications or registrations, called as IP Family, for distribution according to at least one of the following: from the at least one IP Case to the at least one IP Family and from the at least one IP Family to the at least one IP Case that belongs to the IP Family on a user interface run by any user access device;
a computer readable code for linking the data marked for distribution on at least one server according to a data structure;
   wherein the computer program product further comprises a computer readable code for
linking the said data on the at least one server according to the data structure as follows:
   the data marked for distribution from the at least one IP Case to the at least one IP Family, is linked to the at least one IP Family; and
   the data marked for distribution from the at least one IP Family to the at least one IP Case that belongs to the IP Family, is linked to the at least one IP Case; and
publishing the said data according to linking in the data structure on the server for a user's access on the user interface run by any user access device.

The basic idea of the invention is as follows: The basic idea of the present invention relies on effective self-direction of data on the server according to a data structure. The self-direction of the data is achieved by enabling one or more users to work asynchronously with capability to define the relevant data to be distributed that the server then distributes from an IP Case to an IP Family level or from IP Family level to one or more IP Cases in the IP Family according to the data structure on the server. Further, the server publishes the distributed data for user's access on the level of the one or more IP Cases or the one or more IP Families.

The present invention may be implemented as a secure web service over HTTP protocol enabled to dynamically generate web pages and utilizing one or more relational database servers. The present invention may also be implemented as a stand-alone client software with static web pages. The present invention may also be implemented with an alternative solution instead of a database. Further, the present invention may be implemented as any combination of the previous implementation possibilities.

In one advantageous embodiment of the invention any data marked for distribution by a user on the level of an IP Case is distributed by a server according to a data structure on the server to the level of an IP Family to which the IP Case belongs to. Further, the server publishes the data marked for distribution for any user's access directly on the IP Family. This would be the case when any new data is added to the IP Case and the user considers that the data is relevant also on the level of the IP Family and possible other IP Cases that may belong to the IP Family, for example.

In another advantageous embodiment of the invention any data marked for distribution by a user on the level of an IP Family is distributed by a server according to a data structure on the server to one or more IP Cases that belong to the IP Family. Further, the server publishes the data marked for distribution for any user's access directly on the new IP Case. This would be the case when one or more new IP Cases are added to the IP Family and the IP Family already holds data that may be relevant to any IP Case in it, for example.

In a third advantageous embodiment of the invention a server may collect any data marked for distribution from an IP Case to an IP Family or from an IP Family to an IP Case in to a Log for Collecting comments keeping list of additions or changes in relation to the said data. The Log for Collecting comments enables even more fluent access to any user of the IP Management system to the data that is of importance either on the level of the single IP Case or the IP Family.

In a fourth advantageous embodiment of the invention an IP Case and an IP Family are associated with each other together by a data structure on the server with at least one element of Workspace that comprises a log for collecting comments. The at least one element of Workspace in a data structure corresponds to at least one of the following: a deadline, a task, a decision or a notification in relation to the at least IP Case and the at least one IP Family.

Further scope of applicability of the present invention will become apparent from the detailed description given hereafter. However, it should be understood that the detailed description and specific examples, while indicating preferred embodiments of the invention, are given by way of illustration only, since various changes and modifications of the invention will become apparent to those skilled in the art from this detailed description.

### BRIEF DESCRIPTION OF THE DRAWINGS

The present invention will become more fully understood from the detailed description given herein below and accompanying drawings which are given by way of illustration only, and thus are not limitative of the present invention and wherein

FIG. 1 shows a schematical representation of the main components of an arrangement according to the invention by way of an example;

FIG. 2a shows an exemplary flow chart for method stages according to the invention;

FIG. 2b shows another exemplary flow chart including main stages of the method according to the invention;

FIG. 2c shows yet another exemplary flow chart for method stages according to the invention; and

FIG. 3 shows, by way of an example only, an object model for a possible data structure for implementation of the invention.

### DETAILED DESCRIPTION

In the following description, considered embodiments are merely exemplary, and one skilled in the art may find other ways to implement the invention. Although the specification may refer to “an”, “one; or “some” embodiment(s) in several locations, this does not necessarily mean that each such reference is made to the same embodiment(s), or that the feature only applies to a single embodiment. Single feature of different embodiments may also be combined to provide other embodiments.

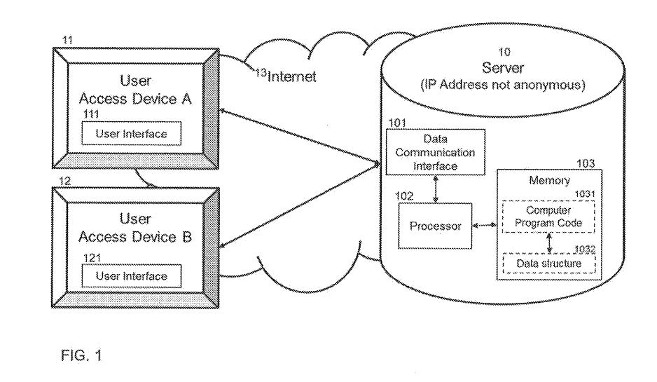

FIG. 1 shows a schematical representation of the main components of an arrangement according to the invention by way of an example. The arrangement according to the present invention has at least one server 10 and is referred as “the server” later in the description. The server 10 implements the logic of the arrangement for data distribution in an IP management system. The server 10 may run such IP management system.

The server 10 essentially comprises of at least one processor 102, at least one memory unit 103 containing a computer program code 1031 and a data structure 1032, and at least one data communication interface 101 (“the data communication interface”). The data structure 1032 enables distribution of data in IP management system from one or more IP Cases to a level of an IP Family. Also, the data structure 1032 enables distribution of data in IP management system from the level of an IP Family to one or more IP Cases in the family. The data structure 1032 enables effective self-direction of the IP Case and IP Family data on the server 10. The data communication interface 101 enables the communication with at least one user access device (11 and 12) over the Internet 13. Advantageously, the server 10 may be implemented as a web server with high data security and a fixed Internet Protocol (IP) address. The fixed IP address means that the IP address is not anonymous.

Further, the arrangement also comprises at least one user access device (11 and 12) with capability to run a user interface (111 and 121). The user interface provides access to the IP management system for a user. The at least one user access device (11 and 12) may be, for example, a PC, a laptop, a tablet, a mobile phone or other such device, which comprises of at least one processor, at least one memory unit and at least one data communication interface that enable the at least one user access device (11 and 12) to connect to the server 10 over the Internet 13. The connection over the Internet 13 may be provided with high data security. Advantageously, the user interface (111 and 121) may be accessed with a web browser run by the at least one user access device (11 and 12).

Advantageously, the arrangement enables one or more users to work asynchronously on through the user interface (111 and 121) on any user access device (11 and 12) with capability to define the relevant data to be distributed on the user interface (111 and 121) that the server 10 then distributes from an IP Case to an IP Family level or from IP Family level to one or more IP Cases in the IP Family according to the data structure 1032. Moreover, the arrangement enables the users to work asynchronously on through the user interface (111 and 121) on any user access device (11 and 12) on the level of the IP Case or the IP Family and have direct access to the data that is of importance on either level without separate searches for the data.

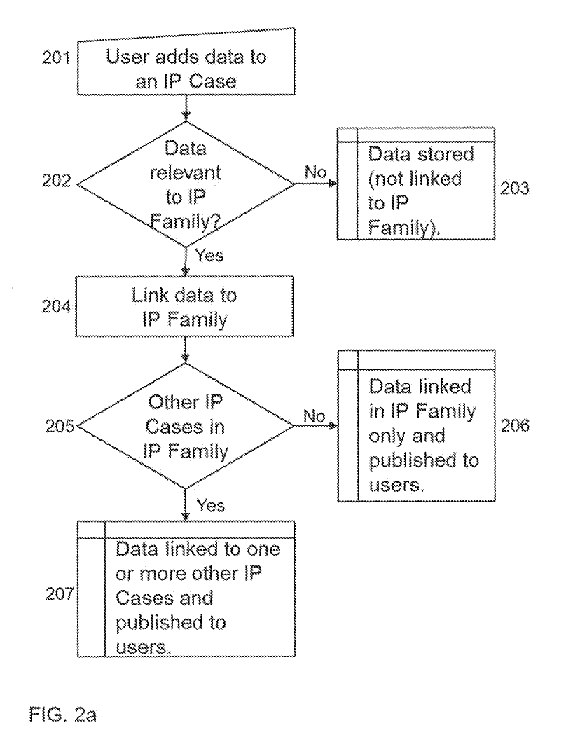

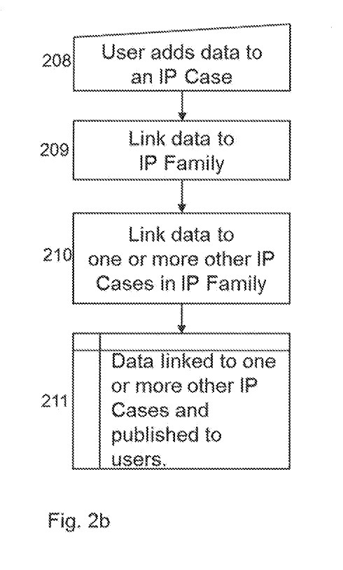

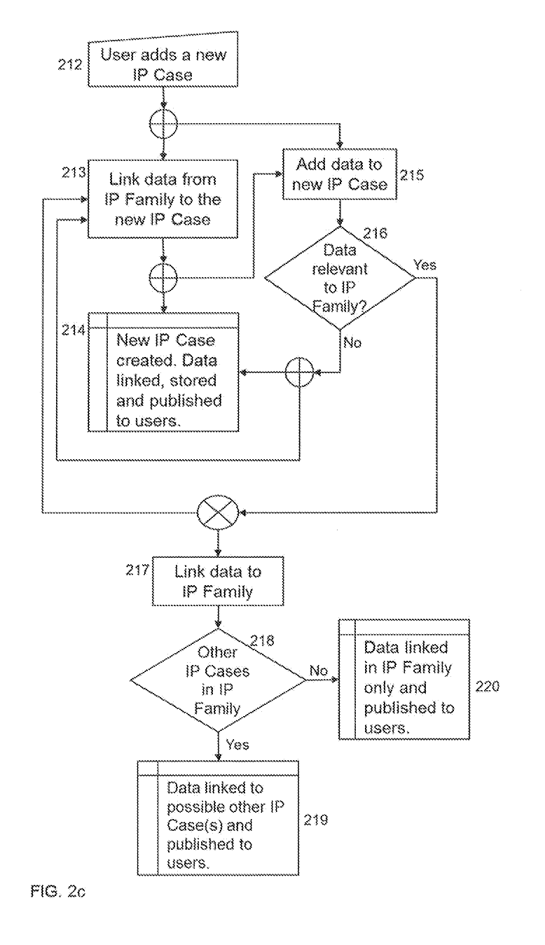

FIG. 2a shows an exemplary flow chart for method stages according to the invention. In this exemplary embodiment, a user adds data to at least one IP Case (hereinafter “the IP Case”) that exists in an IP management system. The IP management system is run on the server 10 (according to FIG. 1). In step 201 the user starts the process by adding any data to the IP Case through the user interface (111, 121) of the user access device (11, 12). The data may be, for example, at least one of the following: a deadline, a comment relating to a deadline, a document, a comment relating to a document, a task relating to a deadline, a task without a deadline, a general note regarding the IP Case with information that may be of importance in later phases of prosecution of the IP Case or an IP Family that the IP Case belongs to.

In the step 202 the relevance of the added data for IP Family that the IP Case belongs to is assessed. Advantageously, the user may mark on the user interface (111, 121) that the added data is relevant to the IP Family in step 202. More advantageously, the user may mark the added data to be relevant to the IP Family on the user interface (111, 121) through at least one of the following: a pull-down menu, a tick box, a selectable icon and a selectable text, for example.

If the added data is not relevant for the IP Family, step 203 is taken by the server 10. In step 203 the added data is stored in the IP management system by the server but no linking with the IP Family is established by the server 10 according to the data structure 1032. As a consequence of step 203, the added data is still stored in the IP management system and may be accessed according to the IP Case that the data belongs to or by using any search function that the IP management system may provide. However, if any user of the IP management system reviews the IP Family through the user interface (111, 121) of any user access device (11, 12), the data added to the IP Case in step 201 is not directly accessible from the level of the IP Family. Naturally, access rights provided to the users in the IP management system may further limit what the users are allowed to view within the IP management system.

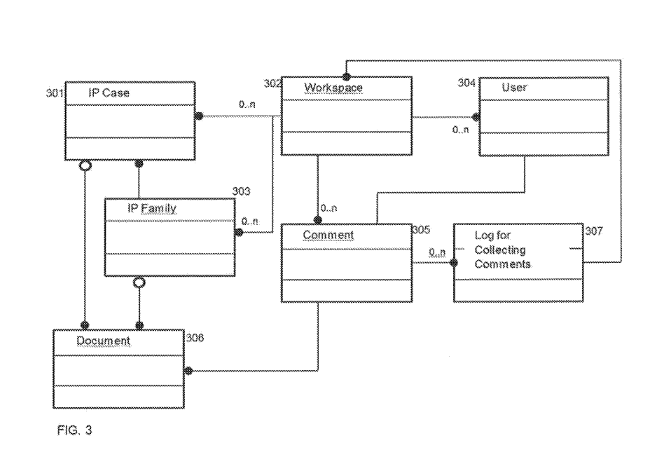

If the user marks the added data to be relevant to the IP Family in step 202, step 204 is taken by the server 10 and the data added in the IP Case becomes the data marked for distribution. In step 204 the server 10 links the data marked for distribution from the IP Case to the IP Family according to the data structure 1032. An example of possible object model for the data structure 1032 will be given in FIG. 3.

The server proceeds to step 205 in which the server 10 checks if one or more other IP Cases exists in the IP Family and chooses the next action accordingly.

If there are no other IP Cases in the IP Family, step 206 is taken by the server 10. In step 206 the data marked for distribution is distributed to the IP Family and published to the users of the IP management system for access through the user interface (111, 121) of any user access device (11, 12) on the level of the IP Family along with the level of the IP Case by the server 10. Advantageously, any user of the IP management system is now able to see the data marked for distribution on the level of the IP Family. To enable even more easier to access to the data marked for distribution on the level of the IP Family, the server may, advantageously, publish the added data in a Log for Collecting Comments that collects the data that has been marked for distribution. The Log for Collecting Comments may, more advantageously, be visible both on the level of an IP Case and on the level of the IP Family.

If at least one other IP Case exists in the IP Family, step 207 is taken by the server 10. In step 207 the data marked for distribution is linked to the at least one other IP Case that belongs to the IP Family by the server 10 according to the data structure 1032. In step 207 the data marked for distribution is distributed to the IP Family at least one other IP Case in the IP Family. Further, in step 207 the data marked for distribution is published to the users of the IP management system for access through the user interface (111, 121) of any user access device (11, 12) on the level of the IP Family along with the level any of the one or more IP Cases in the IP Family by the server 10. Advantageously, any user of the IP management system is now able to see the data marked for distribution on the level of the IP Family and on the level of any of the one or more IP Cases in the IP Family. To enable even more fluent access to the data marked for distribution on the level of the IP Family or on the level of any of the one or more IP Cases in the IP Family, the server may, advantageously, publish the added data in a Log for Collecting Comments that collects the data that has been marked for distribution. The Log for Collecting Comments may, more advantageously, be visible both on the level of a single IP Case and on the level of the IP Family.

More advantageously, the Log for Collecting Comments may, on the level of a single IP Case or on the level of an IP Family, also store a diary of all the changes and additions to the data related to them. The user may access the Log for Collecting Comments from both levels. The data may be, for example, at least one of the following: a deadline, a comment relating to a deadline, a document, a comment relating to a document, a task relating to a deadline, a task without a deadline, a general note regarding the IP Case with information that may be of importance in later phases of prosecution of the IP Case or an IP Family that the IP Case belongs to. Advantageously, if the user works on the level of the IP Family, the user may mark the added or changed data to be relevant one or more IP Cases in the IP Family on the Log for Collecting Comments through at least one of the following: a pull-down menu, a tick box, a selectable icon and a selectable text, for example. Also advantageously, if the user works on the level of the single IP Case, the user may mark the added or changed data to be relevant to the IP Family on the Log for Collecting Comments through at least one of the following: a pull-down menu, a tick box, a selectable icon and a selectable text, for example.

Advantageously according to this embodiment, one or more users may work asynchronously on through the user interface (111 and 121) on any user access device (11 and 12) with capability to define the relevant data to be distributed on the user interface (111 and 121) that the server 10 then distributes from an IP Case to an IP Family level or from IP Family level to one or more IP Cases in the IP Family according to the data structure 1032. Moreover, the arrangement enables the users to work asynchronously on through the user interface (111 and 121) on any user access device (11 and 12) on the level of the IP Case or the IP Family and have direct access to the data that is of importance on either level without separate searches for the data.

FIG. 2b shows another exemplary flow chart including main stages of the method according to the invention. In this exemplary embodiment, a user adds data to at least one IP Case (hereinafter “the IP Case”) that exists in an IP management system. The IP management system is run on the server 10 (according to FIG. 1). In step 208 the user starts the process by adding any data to the IP Case through the user interface (111, 121) of the user access device (11, 12). The data may be, for example, at least one of the following: a deadline, a comment relating to a deadline, a document, a comment relating to a document, a task relating to a deadline, a task without a deadline, a general note regarding the IP Case with information that may be of importance in later phases of prosecution of the IP Case or an IP Family that the IP Case belongs to.

According to step 209, the server 10 links the data added to the IP Case to the IP Family according to data structure 1032. An example of possible object model for the data structure 1032 will be given in FIG. 3. The server 10 proceeds to step 210 in which the server 10 checks if any other IP Cases exist in the IP Family that the data was linked in the previous step. In step 211, if one or more other IP Cases exist in the IP family, the server 10 distributes the added data to the one or more other IP Cases in the IP family by linking the data according to the data structure 1032. Further, the server 10 publishes the added data to the users of the IP management system for access through the user interface (111, 121) of any user access device (11, 12) on the level of the IP Family along with the level any of the one or more IP Cases in the IP Family. Advantageously, any user of the IP management system is now able to see the data marked for distribution on the level of the IP Family and on the level of any of the one or more IP Cases in the IP Family. To enable even more fluent access to the data marked for distribution on the level of the IP Family or on the level of any of the one or more IP Cases in the IP Family, the server may, advantageously, publish the added data in a Log for Collecting Comments that collects the data that has been marked for distribution. The Log for Collecting Comments may, more advantageously, be visible both on the level of a single IP Case and on the level of the IP Family. If no other IP Cases exist in the said IP Family, the data is only linked on the level of the IP Family.

FIG. 2c shows an exemplary flow chart for method stages according to the invention. In this example, a user may add a new IP Case (hereinafter “the IP Case”) to the IP management system. The IP management system is run on the server 10 (according to FIG. 1). In step 212 the user starts the process by creating the IP Case to the IP management system on the user interface (111, 121) of any user access device (11, 12) allowing access to the IP management system. According to the invention there are different possibilities to proceed further.

In one advantageous embodiment, step 213 is taken next. In step 213 the user may connect the IP Case to an IP Family on the user interface (111, 121) of any user access device (11, 12). Further in step 213 the server 10 may then link data from the IP Family to the IP Case if there is data in the IP Family that has been marked to be distributed according to the data structure 1032. That data will then be distributed from the IP Family to the IP Case. Advantageously, the user may be allowed to choose on the user interface (111, 121) if any data from the IP Family is to be published to the IP Case by the server 10. An example of possible object model for the data structure 1032 will be given in FIG. 3. More advantageously, the user may mark the data from the IP Family to be published to the IP Case on the user interface (111 and 121) through at least one of the following: a pull-down menu, a tick box, a selectable icon and a selectable text, for example.

In step 214 the new IP Case is created on the server 10. Possible data from the IP Family is distributed to the IP Case by the server 10 according to linking in the data structure 1032. The data distributed from the IP Family is published to the IP Case by the server. Advantageously, the possible data from the IP Family is distributed to the IP Case by the server 10 according to linking in the data structure 1032 if the user has chosen the data to be distributed and published to the IP Case. Advantageously, any user of the IP management system is now able to see the data marked for distribution on the level of the IP Family also on the level of the new IP Case that has been added to the IP Family. To enable even more fluent access to the data from the level of the IP Family also on the level of the IP Case, the server 10 may, advantageously, publish the said data in a Log for Collecting Comments that collects the data that has been marked for distribution. The Log for Collecting Comments may, more advantageously, be visible both on the level of a single IP Case and on the level of the IP Family. Moreover, the log for collecting comments (307) may be advantageously configured to provide access to one or more users on the user interface (111, 121) of the at least one user access device (11, 12) to mark any data in at least one of the following: one IP Case or one or more IP Family, for distribution within the IP management system (202, 216) by the server (10).

Further in this advantageous embodiment, the user may also choose on the user interface (111, 121) to add data to the new IP Case according to step 215 when the IP Case is being created by the user. This may, for example, take place after step 212 or after step 213. In step 215 the user starts the process by adding any data to the IP Case through the user interface (111, 121) of the user access device (11, 12). The data may be, for example, at least one of the following: a deadline, a comment relating to a deadline, a document, a comment relating to a document, a task relating to a deadline, a task without a deadline, a general note regarding the IP Case with information that may be of importance in later phases of prosecution of the IP Case or an IP Family that the IP Case belongs to.

In the step 216 the relevance of the added data for IP Family that the IP Case belongs to is assessed. Advantageously, the user may mark on the user interface (111, 121) that the added data is relevant to the IP Family in step 216. More advantageously, the user may mark the added data to be relevant to the IP Family on the user interface (111, 121) through at least one of the following: a pull-down menu, a tick box, a selectable icon and a selectable text, for example.

If the added data is not relevant for the IP Family, step 213 or 214 is taken by the server 10 depending on which steps were taken earlier by the server 10. If step 213 has been executed previously as described above by the server 10, then step 214 may be taken after step 215 and step 214 is executed according to the description above by the server 10. However, if step 213 was not executed earlier by the server 10, then step 213 will be taken after step 215 and step 213 is executed according to the description above by the server 10 after which step 214 may be taken by the server 10.

If the user marks the added data to be relevant to the IP Family in step 216, steps 214 and 217 are taken by the server 10. The data added to the IP Case and marked by the user in step 216 becomes the data marked for distribution. Advantageously, the server 10 may execute the steps 214 and 217 in any order. Step 214 is executed by the server 10 according to the description above.

According to step 217 the data marked for distribution is distributed from the IP Case to the IP Family by the server 10 according to linking of the said data created by the data structure 1032.

The server 10 proceeds to step 218 in which the server 10 checks if one or more other IP Cases exists in the IP Family and chooses the next action accordingly.

If there are no other IP Cases in the IP Family, step 220 is taken by the server 10. In step 220 the data marked for distribution is distributed to the IP Family and published to the users of the IP management system for access through the user interface (111, 121) of any user access device (11, 12) on the level of the IP Family along with the level of the IP Case by the server 10. Advantageously, any user of the IP management system is now able to see the data marked for distribution on the level of the IP Family. To enable even more easier to access to the data marked for distribution on the level of the IP Family, the server may, advantageously, publish the added data in a Log for Collecting Comments that collects the data that has been marked for distribution. The Log for Collecting Comments may, more advantageously, be visible both on the level of an IP Case and on the level of the IP Family.

If at least one other IP Case exists in the IP Family, step 219 is taken by the server 10. In step 219 the data marked for distribution is linked to the at least one other IP Case that belongs to the IP Family by the server 10 according to the data structure 1032. In step 219 the data marked for distribution is distributed to the IP Family and the at least one other IP Case in the IP Family. Further, in step 219 the data marked for distribution is published to the users of the IP management system for access through the user interface (111, 121) of any user access device (11, 12) on the level of the IP Family along with the level any of the one or more IP Cases in the IP Family by the server 10. Advantageously, any user of the IP management system is now able to see the data marked for distribution on the level of the IP Family and on the level of any of the one or more IP Cases in the IP Family. To enable even more fluent access to the data marked for distribution on the level of the IP Family or on the level of any of the one or more IP Cases in the IP Family, the server may, advantageously, publish the added data in a Log for Collecting Comments that collects the data that has been marked for distribution. The Log for Collecting Comments may, more advantageously, be visible both on the level of a single IP Case and on the level of the IP Family.

More advantageously, the Log for Collecting Comments may, on the level of a single IP Case or on the level of an IP Family, also store a diary of all the changes and additions to the data related to them. The user may access the Log for Collecting Comments from both levels. The data may be, for example, at least one of the following: a deadline, a comment relating to a deadline, a document, a comment relating to a document, a task relating to a deadline, a task without a deadline, a general note regarding the IP Case with information that may be of importance in later phases of prosecution of the IP Case or an IP Family that the IP Case belongs to. Advantageously, if the user works on the level of the IP Family, the user may mark the added or changed data to be relevant one or more IP Cases in the IP Family on the Log for Collecting Comments through at least one of the following: a pull-down menu, a tick box, a selectable icon and a selectable text, for example. Also advantageously, if the user works on the level of the single IP Case, the user may mark the added or changed data to be relevant to the IP Family on the Log for Collecting Comments through at least one of the following: a pull-down menu, a tick box, a selectable icon and a selectable text, for example.

Advantageously, according to this embodiment, one or more users may work asynchronously on through the user interface (111 and 121) on any user access device (11 and 12) with capability to define the relevant data to be distributed on the user interface (111 and 121) that the server 10 then distributes from an IP Case to an IP Family level or from IP Family level to one or more IP Cases in the IP Family according to the data structure 1032. Moreover, the arrangement enables the users to work asynchronously on through the user interface (111 and 121) on any user access device (11 and 12) on the level of the IP Case or the IP Family and have direct access to the data that is of importance on either level without separate searches for the data.

FIG. 3 shows, by way of an example only, object model for a possible data structure for implementation of the invention. The data structure 1032 on the memory 103 on the server 10 according to the invention in this advantageous embodiment comprises the following elements having certain relations: at least one IP Case 301, at least one Workspace 302, at least one IP Family 303, at least one User 304, at least one Comment 305, at least one Document 306 and at least one Log for Collecting Comments 307. The exemplary data structure comprising the previous elements may be applied to the implementation of the present invention as follows:

There may be a plurality of IP Cases 301 that may belong to one or more IP Families 303. There may also be a plurality of Workspaces 302 that relate to an IP Case 301 or an IP Family 303. In this embodiment a Workspace 302 acts as an element in the data structure that connects at least one IP Case 301 to at least one IP Family 303 by allowing one more users 304 to share tasks and data on the level of the least one IP Case 301 or at least one IP Family 303. Each IP Case 301 may have a plurality of Workspaces 302. Also, each IP Family 303 may have a plurality of Workspaces 302. Each Workspace 302 may have one more Users 304 working with it. One of the Users 304 may be a responsible for the Workspace 302. Further, each Workspace 302 may have a plurality of Comments 305 created by one or more Users 304. Each Comment 305 has a certain identified user 304 as an author. Each Comment 305 may relate to a Document 306. The Document 306 may relate to one or more IP Cases 301 or one or more IP Families 303. Each Workspace 302 may comprise a Log for Collecting Comments 307. The Log for Collecting Comments 307 may comprise one or more Workspaces

The Workspace 302 enables collecting one or more Comments 305 in to the Log of Collecting Comments 307. The Workspace 302 enables one or more Users 304 who are working asynchronously with one or more IP Cases 301 or one or more IP Families 303 to distribute data from the level of an IP Family 303 to the level of an IP Case 301. The Workspace 302 enables one or more Users 304 who are working asynchronously with one or more IP Cases 301 or one or more IP Families 303 to distribute data from the level of an IP Case 301 to the level of an IP Family 303.

The distributable data may comprise at least one of the following: comments 305, documents 306 with comments 305, documents 306, tasks as a form of Workspace 302, notifications as a form of Workspace 302, deadlines as a form of Workspace 302 and other such items, for example.

Advantageously, the at least one IP Case 301 and the at least one IP Family 303 are linked together by the data structure 1032 with at least one element of Workspace 302 that comprises the Log for Collecting Comments 307.

Although this exemplary embodiment contains the Workspace 302, a data structure without the Workspace 302 as element is also possible. In that case, one or more Comments 305 may be directly associated with one or more IP Cases 301 or one or more IP Families 303. Still the data structure 1032 may enable the server 10 to collect one or more Comments 305 in to the Log of Collecting Comments 307. Also, the data structure advantageously enables one or more Users 304 who are working asynchronously with one or more IP Cases 301 or one or more IP Families 303 to distribute data from the level of an IP Family 303 to the level of an IP Case 301. Moreover, the data structure advantageously enables Users 304 who are working asynchronously with one or more IP Cases 301 or one or more IP Families 303 to distribute data from the level of an IP Case 301 to the level of an IP Family 303.

Any of the steps described or illustrated herein may be implemented using executable instructions in a general-purpose or special-purpose processor and stored on a computer-readable storage medium (e.g., disk, memory, or the like) to be executed by such a processor. References to ‘computer-readable storage medium’ and ‘computer’ should be understood to encompass specialized circuits such as field-programmable gate arrays, application-specific integrated circuits (ASICs), USB flash drives, signal processing devices, and other devices

Indeed, some significant detail regarding the computer must be provided, such as regarding: (i) a “memory” and a “processor” and regarding other elements of the computer and processor, (ii) what specific steps of the pertinent method the processor, memory, and these other elements can perform, and (iii) how the processor and memory and other components of the computer interrelate and work together. At a minimum, the description should also include a block diagram and flow charts illustrating this interrelationship. For a process invention where, for example, a “processor” carries out all the steps of the process, it is insufficient to say merely that the process can be implemented by a “processor.” The processor needs to be divided into at least a few functional modules, each such module implementing one step of the process. Further, some details regarding the processor modules should be provided in the description, such as regarding what specific steps of the process the modules can perform, and how the modules interrelate and work together to perform the process.

Some advantageous embodiments of the arrangement, the method, the server and the computer program product for data distribution in an IP management system according to the invention have been described above. The invention is not limited to the solutions described above, but the inventive idea can be applied in numerous ways within the scope of the claims.

1. An arrangement for data distribution in an intellectual property, IP, management system, the arrangement comprising:
at least one user access device configured to run a user interface providing access to the IP management system with a capability to mark any data in at least one of the following:
at least one IP application or registration, called as IP Case, or at least one group of IP applications or registrations, called as IP Family, for distribution within the IP management system; and
at least one server configured to distribute the data marked for distribution on the at least one user access device from the at least one IP Case to the at least one IP Family or from the at least one IP Family to the at least one IP Case that belongs to the IP Family;
wherein the server 404 further comprises a data structure for linking the data marked for distribution on the user access device as follows:
the data marked for distribution from the at least one IP Case to the at least one IP Family, is linked to the at least one IP Family according to the data structure; and
the data marked for distribution from the at least one IP Family to the at least one IP Case that belongs to the IP Family, is linked to the at least one IP Case according to the data structure; and
the server is configured to publish the said data according to the linking in the data structure for a user's access on the user interface run by any user access device.

2. The arrangement according to claim 1 wherein the server is further configured to publish the data marked for distribution for a user's access through the at least user interface on any user access device to a new IP Case when the new IP Case is added to at least one IP family according to the linking in the data structure.

3. The arrangement according to claim 1 wherein the server is further configured to publish the data marked for distribution in a log for collecting comments in relation to the data and the log for collecting comments is connected to the at least one IP Case and the at least one IP Family by the data structure.

4. The arrangement according to claim 3 wherein the log for collecting comments is further configured to provide access to a user on the user interface of the at least one user access device to mark any data in at least one of the following: one IP Case or one or more IP Family, for distribution within the IP management system by the server.

5. The arrangement according to claim 3 wherein the at least IP Case and the at least one IP Family are linked together by the data structure with at least one element of Workspace that comprises the log for collecting comments and the at least one element of Workspace corresponds to at least one of the following: a deadline, a task, a decision or a notification in relation to the at least IP Case and the at least one IP Family.

6. The arrangement according to claim 1 wherein marking the data for distribution on the user interface is accomplished by at least one of the following a pull-down menu, a tick box, a selectable icon and a selectable text.

7. A server for data distribution in an intellectual property, IP, management system, the server comprising:
at least one processor;
at least one data communication interface;
at least one memory including a computer program code and a data structure; and
the at least one memory, the computer program code and the data structure configured with the at least one processor, to cause the server at least to distribute any data marked for distribution in at least one IP application or registration, called as IP Case, or at least one group of IP applications or registrations, called as IP Family, on a user interface run by at least one user access device providing access to the IP management system
wherein the server is further configured to publish the data for a user's access on the user interface providing access to the IP management system run by any user access device according to the data structure linking the data as follows:
the data marked for distribution from the at least one IP Case to the at least one IP Family, is linked to the at least one IP Family; and
the data marked for distribution from the at least one IP Family to the at least one IP Case that belongs to the IP Family, is linked to the at least one IP Case.

8. The server according to claim 7 wherein the server is further configured to publish the data marked for distribution for a user's access through the at least user interface on any user access device to a new IP Case when the new IP Case is added to at least one IP family according to the linking in the data structure.

9. The server according to claim 7 wherein the server is further configured to publish the data marked for distribution in a log for collecting comments keeping list of additions or changes in relation to the data and the log for collecting comments is connected to the at least one IP Case and the at least one IP Family by the data structure.

10. The server according to claim 9 wherein the server is further configured to provide access for a user through the user interface of the at least one user access device to mark any data in at least one of the following: one IP Case or one or more IP Family, for distribution within the IP management system in the log for collecting comments.

11. The server according to claim 9 wherein the at least one IP Case and the at least one IP Family are linked together by the data structure with at least one element of Workspace that comprises the log for collecting comments and the at least one element of Workspace corresponds to at least one of the following: a deadline, a task, a decision or a notification in relation to the at least one IP Case and the at least one IP Family.

12. A method for data distribution in an intellectual property, IP, management system, the method comprising:
marking any data in at least one IP application or registration, called as IP Case, or in at least one group of IP applications or registrations, called as IP Family, for distribution according to at least one of the following: from the at least one IP Case to the at least one IP Family and from the at least one IP Family to the at least one IP Case that belongs to the IP Family on a user interface providing access to the IP management system run by any user access device; and
linking the data marked for distribution on at least one server according to a data structure
wherein the method further comprises linking the data on the at least one server according to the data structure as follows:
the data marked for distribution from the at least one IP Case to the at least one IP Family, is linked to the at least one IP Family;
the data marked for distribution from the at least one IP Family to the at least one IP Case that belongs to the IP Family, is linked to the at least one IP Case; and
the data is published by the at least one server according to linking in the data structure for a user's access on the user interface run by any user access device.

13. The method according to claim 12 wherein the method further comprises publishing the data marked for distribution for a user's access through the at least user interface on any user access device to a new IP Case when the new IP Case is added to at least one IP family according to the linking in the data structure on the server.

14. The method according to claim 12 wherein the method further comprises publishing the data marked for distribution in a log for collecting comments keeping list of additions or changes in relation to the data and the log for collecting comments is connected to the at least one IP Case and the at least one IP Family by the data structure on the server.

15. The method according to claim 14 wherein the method further comprises providing access for a user through the user interface of the at least one user access device to mark any data in at least one of the following: one IP Case or one or more IP Family, for distribution within the IP management system on the server in the log for collecting comments.

16. The method according to claim 14 wherein the at least one IP Case and the at least one IP Family are linked together on the server by the data structure with at least one element of Workspace that comprises the log for collecting comments and the at least one element of Workspace corresponds to at least one of the following: a deadline, a task, a decision or a notification in relation to the at least one IP Case and the at least one IP Family.

17. The method according to claim 12 wherein the method further comprises marking the data for distribution on the user interface through at least one of the following a pull-down menu, a tick box, a selectable icon and a selectable text.

18. A computer program product on a non-transitory media for data distribution in an intellectual property, IP, management system, the computer program product comprising:
a computer readable code for marking any data in at least one IP application or registration, called as IP Case, or at least one group of IP applications or registrations, called as in IP Family, for distribution according to at least one of the following: from the at least one IP Case to the at least one IP Family and from the at least one IP Family to the at least one IP Case that belongs to the IP Family on a user interface run by any user access device; and
a computer readable code for linking the data marked for distribution on at least one server according to a data structure;
wherein the computer program product further comprises a computer readable code for
linking the data on the at least one server according to the data structure as follows:
the data marked for distribution from the at least one IP Case to the at least one IP Family, is linked to the at least one IP Family; and
the data marked for distribution from the at least one IP Family to the at least one IP Case that belongs to the IP Family, is linked to the at least one IP Case; and
publishing the said data according to linking in the data structure on the server for a user's access on the user interface run by any user access device.

19. The computer program product according to claim 18 wherein the computer program product further comprises a computer readable code for publishing the data marked for distribution for a user's access through the at least user interface on any user access device to a new IP Case when the new IP Case is added to at least one IP family according to the linking in the data structure on the server.

20. The computer program product according to claim 18 wherein the computer program product further comprises a computer readable code for
publishing the data marked for distribution in a log for collecting comments keeping list of additions or changes in relation to the said data wherein the log for collecting comments is connected to the at least one IP Case and the at least one IP Family by the data structure on the server.

21. The computer program product according to claim 20 wherein the computer program product further comprises a computer readable code for
providing access for a user through the user interface of the at least one user access device to mark any data in at least one of the following: one IP Case or one or more IP Family, for distribution within the IP management system on the server in the log for collecting comments.

22. The computer program product according to claim 18 wherein the computer program product further comprises a computer readable code for marking the data for distribution on the user interface through at least one of the following a pull-down menu, a tick box, a selectable icon and a selectable text.
